(19) United States
(12) Patent Application Publication
(10) Pub. No.: US 2025/0020306 A1
(43) Pub. Date: Jan. 16, 2025

(54) PROTECTIVE SYSTEM FOR VEHICLE AUXILIARY DRIVING LIGHTS

(71) Applicant: Brendan Clarke Yag, West Kingston, RI (US)

(72) Inventor: Brendan Clarke Yag, West Kingston, RI (US)

(21) Appl. No.: 18/762,612

(22) Filed: Jul. 2, 2024

Related U.S. Application Data
(60) Provisional application No. 63/513,304, filed on Jul. 12, 2023.
(60) Provisional application No. 63/519,640, filed on Aug. 15, 2023.
(60) Provisional application No. 63/619,646, filed on Jan. 10, 2024.

(51) Int. Cl. F21S 45/10; B60Q 1/18; F21S 41/20

(52) U.S. Cl. CPC F21S 45/10; B60Q 1/18; F21S 41/285

(57) ABSTRACT

The present invention discloses a light protection system for a vehicle, comprising a light protector designed to safeguard auxiliary driving lights. The light protector includes a detachable semi-flexible auxiliary light protector, a removable lens, and a flexible band. The auxiliary driving lights offer supplementary illumination, complementing or replacing the primary illumination provided by the standard headlamp system. The light protector is specifically engineered to shield the auxiliary driving lights from airborne debris, ensuring their functionality and longevity. The system enhances the safety and durability of the vehicle's lighting components, providing reliable illumination in various driving conditions.

### CROSS-REFERENCE TO RELATED APPLICATION(S)

The present application claims priority benefit of U.S. Provisional Application No. 63/513,304, filed Jul. 12, 2023, U.S. Provisional Application No. 63/519,640, filed Aug. 15, 2023 and U.S. Provisional Application No. 63/619,646, filed Jan. 10, 2024, each of which are incorporated herein by reference in its entirety.

### STATEMENT AS TO FEDERALLY SPONSORED RESEARCH

None.

### BACKGROUND OF THE INVENTION

The present invention relates generally to auxiliary lights, and more particularly an auxiliary light guard or auxiliary light cover.

In general, a whirled stone from a vehicle or an off-road excursion could end up costing some serious money for repairs to auxiliary lights. A popular approach involves using detachable protective grilles or screens that can be mounted in front of the auxiliary driving lights. These grilles are often made of metal or durable plastics and are designed to deflect or absorb impacts from debris while still allowing light to pass through the grille. While providing a more versatile and customizable solution compared to no covers, these protective grilles may still be limited in their flexibility and ease of installation. Furthermore, the design and attachment mechanisms of these grilles may vary, leading to potential compatibility issues with different types of auxiliary driving lights and vehicle models. However, none of these approaches have provided a comprehensive solution that combines the features described in this technology. What is needed is a light guard that protects the auxiliary lights from flying debris and adds a design feature to the vehicle that they are mounted on.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a light protector including a removable semi-flexible auxiliary light protector, a removable lens, and a removable flexible band.

In another aspect, the invention features a light protector including a removable semi-flexible auxiliary light protector, a removable lens, and a removable flexible band, the removable semi-flexible auxiliary light protector including an exterior indentation configured to receive, position and secure the removable flexible band within a body of the removable semi-flexible auxiliary light protector.

In still another aspect, the invention features a light protector including a removable stepped semi-flexible auxiliary light protector, a removable lens, and a removable flexible band, the removable band sized to fit with a step of the removable stepped semi-flexible auxiliary light protector.

These and other advantages of the invention will be further understood and appreciated by those skilled in the art by reference to the following written specification, claims and appended drawings. Any of the embodiments discussed or illustrated can be inter-combined with any of the other embodiments.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 illustrates an exemplary system.

FIG. 2 illustrates an exemplary light protector.

FIG. 3A illustrates components of the exemplary light protector of FIG. 2.

FIG. 3B illustrates Lamin-X® protective films (in clear and various colors) that can be utilized in any of the embodiments herein.

FIG. 3C illustrates protective films (in clear and various colors) that can be utilized in any of the embodiments herein. The films in FIGS. 3B and 3C are examples and can be transparent or translucent.

FIG. 4 illustrates an isomeric view of an alternate embodiment of an exemplary removable semi-flexible auxiliary light protector.

FIG. 5 illustrates a side view of the removable semi-flexible auxiliary light protector.

FIG. 6A illustrates a removable semi-flexible auxiliary light protector 600 is shown in conjunction with a removable flexible band 605.

FIG. 6B illustrates different sizes of bands, which can come in circular, square or any other shapes and in any size, for example 605-XL, 605-X, 605-M, and 605-S.

FIG. 6C shows a nested view of example sizes.

FIG. 7 illustrates an exemplary removable stepped semi-flexible auxiliary light protector.

FIG. 8 illustrates two removable stepped semi-flexible auxiliary light protectors.

FIG. 9 illustrates an exemplary stepped removable semi-flexible auxiliary light protector.

FIG. 10 illustrates a stepped removable semi-flexible auxiliary light protector.

FIG. 11 illustrates an exemplary three inch (3″) square light.

FIG. 12 illustrates a square light with a stepped removable semi-flexible auxiliary light protector.

FIG. 13 illustrates two exemplary three inch (3″) light covers.

FIG. 14 illustrates two 2.75″ light covers with lens.

FIG. 15 illustrates two bands installed on two 2.75″ lights.

FIG. 16 illustrates light covers with various lens installed.

FIG. 17A depicts a process for enhancing vehicle lighting and safeguarding auxiliary lights.

FIG. 17B illustrates the detailed sizing and securing process for light protector components.

FIG. 17C shows procedures for the maintenance and positional adjustment of a light protector.

FIG. 18A outlines the fabrication and assembly of a vehicle light protector.

FIG. 18B presents the selection of materials for constructing a semi-flexible light protector.

FIG. 18C details the design of a lens to ensure both protection and proper light transmission.

FIG. 18D focuses on the material choice for a flexible, secure, and easily replaceable band.

FIG. 19A depicts the components of a vehicle light protection system.

FIG. 19B details the constituent elements of the Light Protector.

### DETAILED DESCRIPTION OF THE PREFERRED EMBODIMENT(S)

It is to be understood that the specific devices and processes illustrated in the attached drawings and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

As used herein, auxiliary driving and fog lights are intended for use as auxiliary lighting but can also be used to replace a vehicle's factory low and high beam headlight(s). Auxiliary lights are designed to improve visibility during night time driving and inclement weather. In some cases, auxiliary driving lights are designed to provide relatively long range illumination forward of an automobile, motorcycle, recreational vehicle, and so forth, which enhance the visibility of distant objects. Auxiliary driving lights are intended to supplement (or to replace) the high-beam of a standard headlamp system and to increase the vehicle's visibility and conspicuity to oncoming traffic.

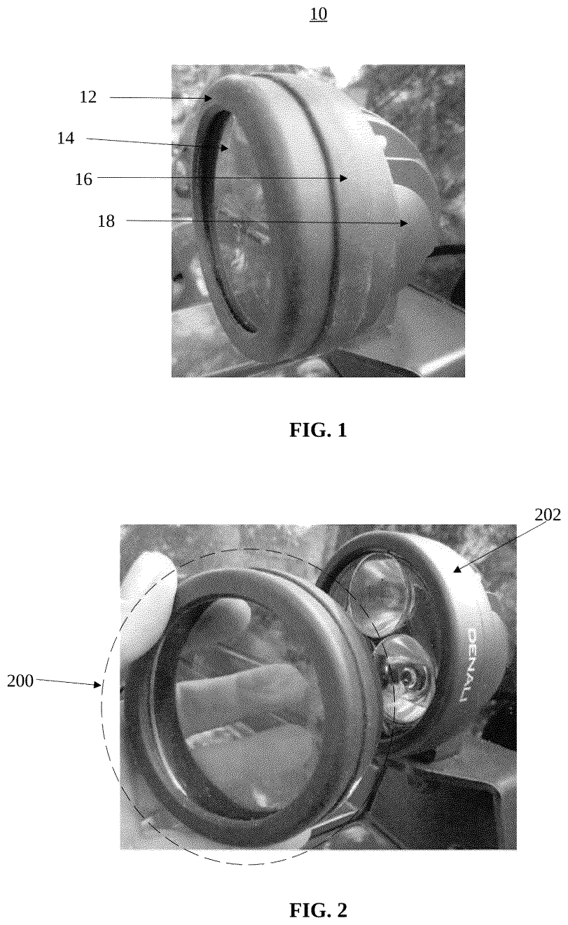

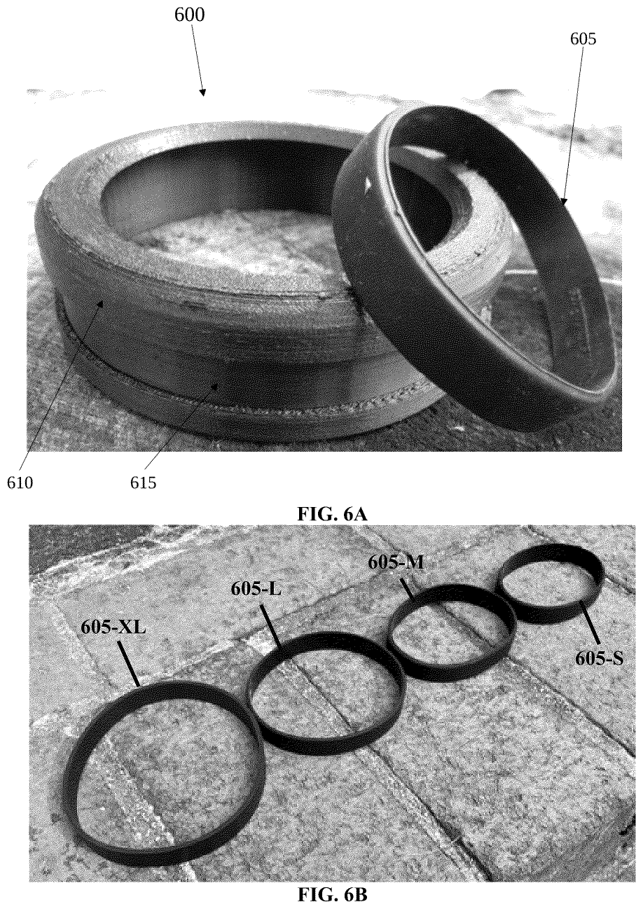

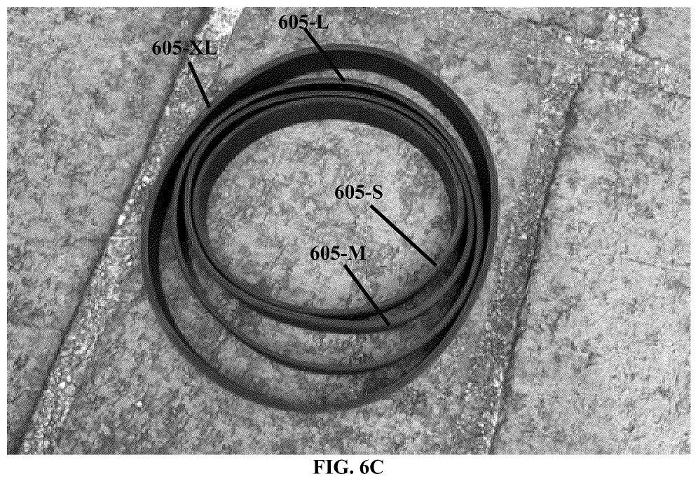

As shown in FIG. 1, a first embodiment of an exemplary system 10 includes a removable semi-flexible auxiliary light protector 12, a removable lens 14, a removable flexible band 16 and an auxiliary light 18. The removable lens 14 is sized to fit within the removable semi-flexible auxiliary light protector 12. The removable semi-flexible auxiliary light protector 1 is sized to fit over and about a perimeter of the auxiliary light 18 and secured in place by the removable band 16. The band 16 can be replaced by a band 605 (FIG. 6A) or a band 910 (FIG. 9).

The removable lens 14 may be clear or tinted in a variety of colors, such as, for example, yellow, orange, black/opaque, red and blue, and so forth.

In this first embodiment, the removable semi-flexible auxiliary light protector 12 is a black silicon injection molded circular disc that is designed to a contour of an individual auxiliary light, such auxiliary light 18. By itself, the removable semi-flexible auxiliary light protector 12 is used for protection from debris and direct ultraviolet (UV) sunlight. This protects a facial area of the auxiliary light's coated/treated material. The removable semi-flexible auxiliary light protector (light cover) may be manufactured in various colors, thicknesses, shapes, and materials.

In this first embodiment, the removable band 16 is used to keep a tight seal around a perimeter of the removable semi-flexible auxiliary light protector 12. The removable band 16 is fitted to a face of the auxiliary light 18, which ensures the removable semi-flexible auxiliary light protector 12 stays in place, as well as keeping the removable lens 14 in place. The removable band 16 can be manufactured in a variety of sizes and colors.

In this first embodiment, the removable lens 14 is designed to create a flat surface barrier when placed within the removable semi-flexible auxiliary light protector 12 to protect the auxiliary light 18. In one example, its design provides a ⅛ inch thick acrylic point of contact for debris, weather and/or other potential damage. The removable lens color can be changed for different ambient light use cases. The removable lens 14 is also a place for protected films and colored films to be applied for added protection and additional color options. The interchangeable removable lens 1 gives consumers an ability to change lens colors quickly, without additional hardware, for their use case application.

As described above, the removable lens 14 may be clear or tinted in a variety of colors, such as, for example, yellow, orange, black/opaque, red and blue, and so forth. For example, a clear lens provides added protection, creating a barrier and place to apply lens treatment.

A yellow removable lens may be employed for low light and nighttime use, for added conspicuity and visibility, as well as aesthetics.

An orange removable lens, also referred to as an amber lens, may emulate an automotive turn signal color and may be used for aesthetics and conspicuity.

A black/opaque lens blocks an LED light entirely even if the LED light is on. The lens may be licensed/branded, custom etched with a logo design for display or aesthetics or used for creating a halo daytime running light (DRL) or through-cut with laser or CNC machine for creating aesthetic shapes for conspicuity. An example of this is a halo shape to be used as a daytime running light.

A red and blue removable lens can indicate off-road use only, or municipal use for police and emergency applications.

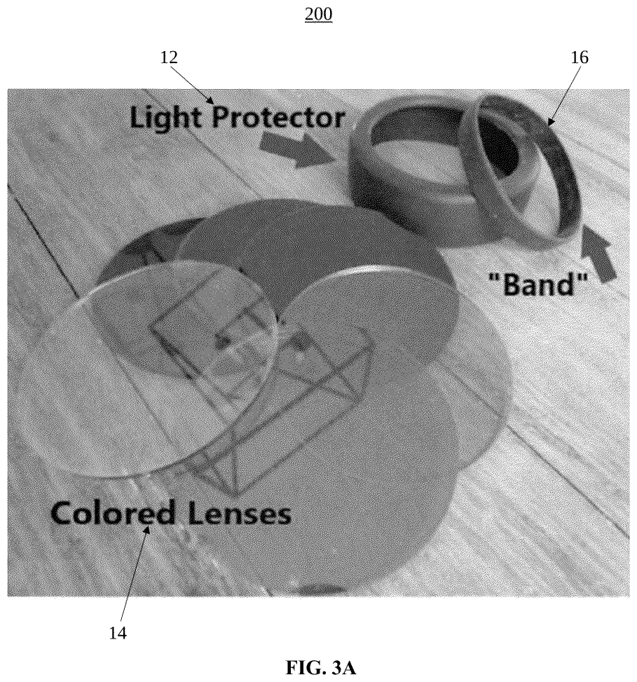

As shown in FIG. 2, the removable semi-flexible auxiliary light protector 12, the removable lens 14, and the removable flexible band 16 make up what is referred herein as a light protector 200. In FIG. 2, a light protector 200 is shown separated from an auxiliary light 202.

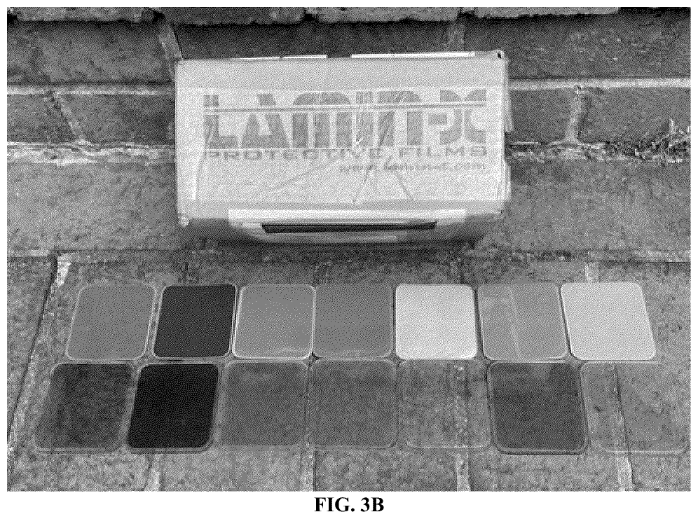

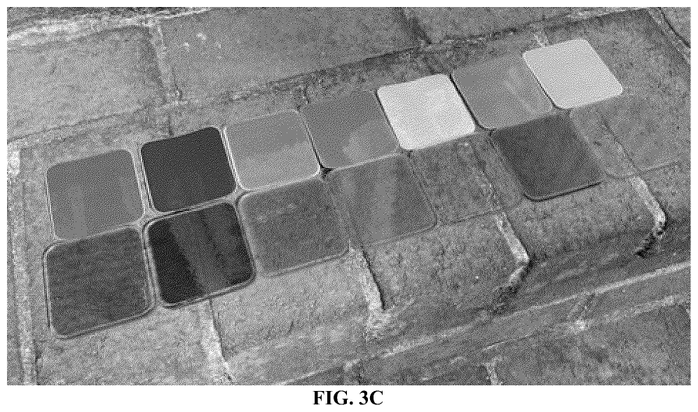

In FIG. 3A, the light protector 200 is shown separated into its individual components, i.e., the removable semi-flexible auxiliary light protector 12, the removable lens 14, and the removable flexible band 16.

The light protector 200 can be installed, removed and re-installed in the rain and with the auxiliary light ON typically in less than 30 seconds. Moreover, the light protector 200 can be easily stored when not in use.

In embodiments, an automotive 3M headlight protection paint film, both clear and photochromatic, can be integrated with the removable lens 14 to add another optional layer of protection. The paint film can protect the removable lens 14. Lamin-X® and/or other colored adhesive films can also be applied to lens for additional film protection, and film color options. The photochromatic film darkens the removable lens 14 when UV light is present, providing an additional layer of protection to the underlying auxiliary light. FIG. 3B illustrates Lamin-X® protective films (in clear and various colors) that can be utilized in any of the embodiments herein. FIG. 3C illustrates protective films (in clear and various colors) that can be utilized in any of the embodiments herein.

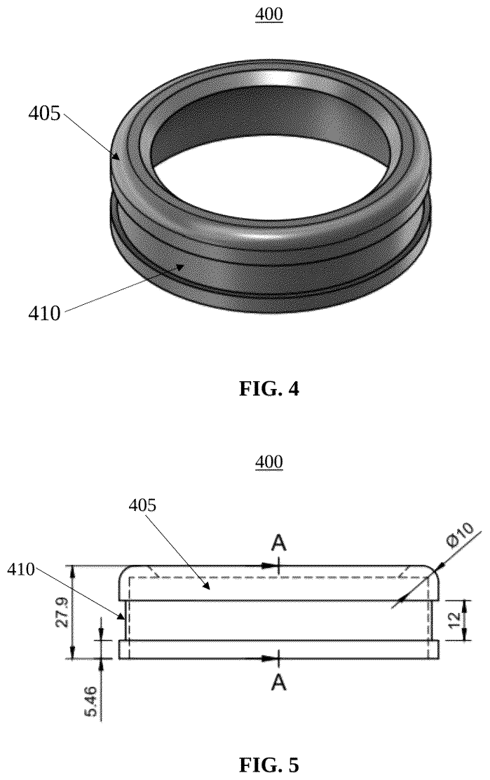

As shown in FIG. 4, an isomeric view of a second embodiment of an exemplary removable semi-flexible auxiliary light protector 400 includes a main body 405 having an indentation (or recess) 410 formed around the main body's exterior. The indentation 410 is sized to receive a removable flexible band (not shown). The indentation 410 provides a location for the removable flexible band that not only places in an optimal position on the removable semi-flexible auxiliary light protector 400 when the light protector 400 is placed over an auxiliary light (not shown), but also inhibits the removable flexible band from moving or sliding once it is placed in the indentation 410.

In FIG. 5, a side view of the removable semi-flexible auxiliary light protector 40 of FIG. is illustrated. Also included in FIG. are exemplary dimensions.

In FIG. 6A, a removable semi-flexible auxiliary light protector 600 is shown in conjunction with a removable flexible band 605. As discussed above, the removable semi-flexible auxiliary light protector 600 includes a main body 610 having an indentation 610 adapted to receive the removable flexible band 605. FIG. 6B illustrates different sizes of bands, which can come in circular or other shapes and in any size, for example 605-XL, 605-X, 605-M, and 605-S. FIG. 6C shows a nested view of example sizes.

As described above, the removable semi-flexible auxiliary light protector and the removable flexible band may be constructed of silicon. In alternate embodiments, the removable semi-flexible auxiliary light protector and/or the removable flexible band may be constructed of rubber.

Moreover, the removable semi-flexible auxiliary light protector may be manufactured using several different materials and processes. For example, rubber and silicon are two materials used with injection molding. However, plastics, powders, resins, metals and carbon fiber may be employed if manufacture by three-dimensional (3D) printing.

As shown in FIG. 7, an isomeric view of a preferred embodiment of an exemplary removable stepped semi-flexible auxiliary light protector 700 includes a main body 705 having a stepped indentation or stepped recess 710 formed around the main body's exterior. The stepped indentation 710 is sized to receive a removable flexible band (not shown). The stepped indentation 710 provides a location for the removable flexible band that not only places in an optimal position on the removable semi-flexible auxiliary light protector 700 when the light protector 700 is placed over an auxiliary light (not shown), but also inhibits the removable flexible band from moving or sliding once it is placed in the stepped indentation 710.

By adding a stepped design, users can install their choice of silicon band onto the light cover with the cover off of the light and prior to installation. The stepped design is flush in height with the band for aesthetics. The acrylic or polycarbonate lens can then be installed into the cover, and the light cover installed onto the light pod. This eliminates the user having difficulty stretching the band over the light cover when the cover is installed on a light.

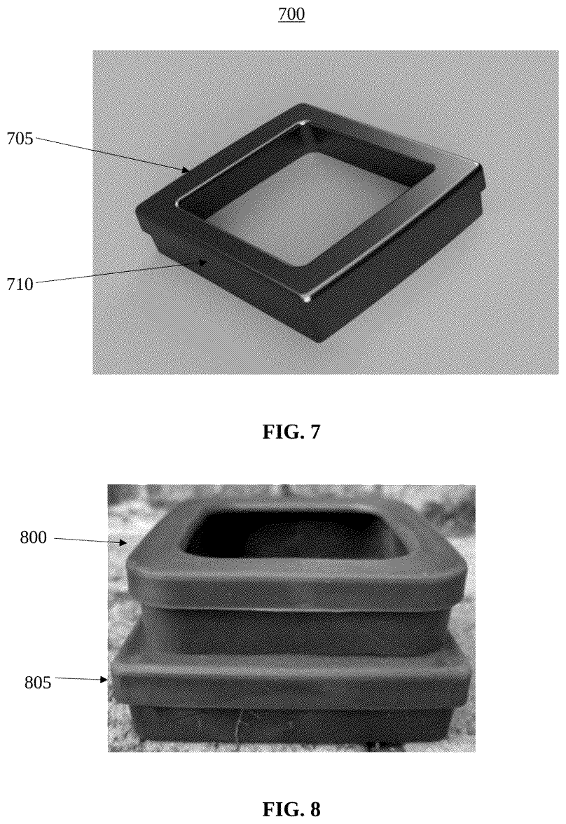

A profile of the stepped indentation design is shown in the two removable semi-flexible auxiliary light protectors 800, 805 illustrated in FIG. 8.

FIG. 9 illustrates an exemplary stepped removable semi-flexible auxiliary light protector 900 without a removable flexible band and an exemplary stepped removable semi-flexible auxiliary light protector 905 with a removable flexible band 910. The various sizes of flexible bands 605 (e.g., XL, L, M, S, FIG. 6A, FIG. 6B, FIG. 6C) can be applied to the flexible band 910.

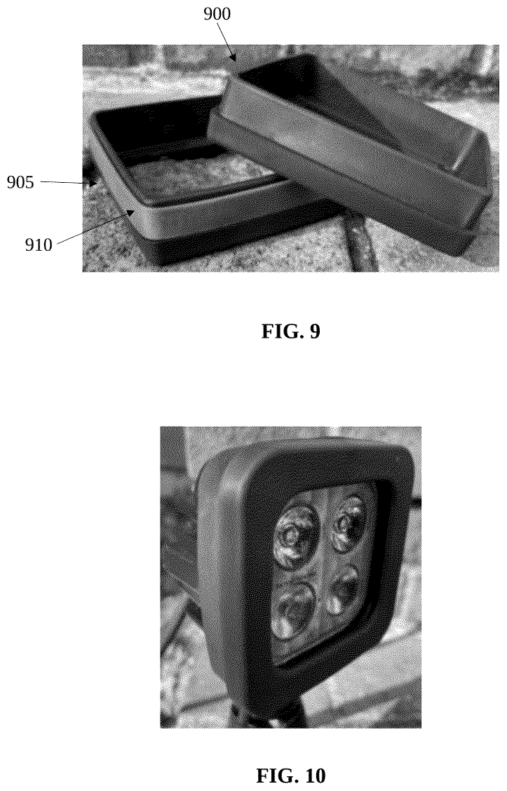

FIG. 10 illustrates a stepped removable semi-flexible auxiliary light protector installed with no lens and no band accessories.

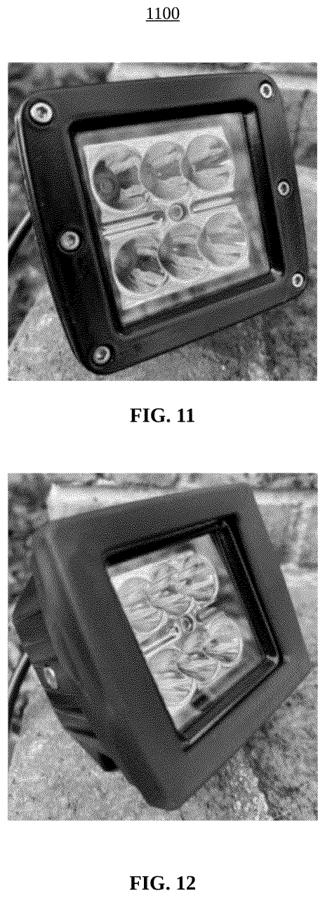

FIG. 11 illustrates an exemplary three inch (3″) square light 1100.

FIG. 12 illustrates a square light with a stepped removable semi-flexible auxiliary light protector.

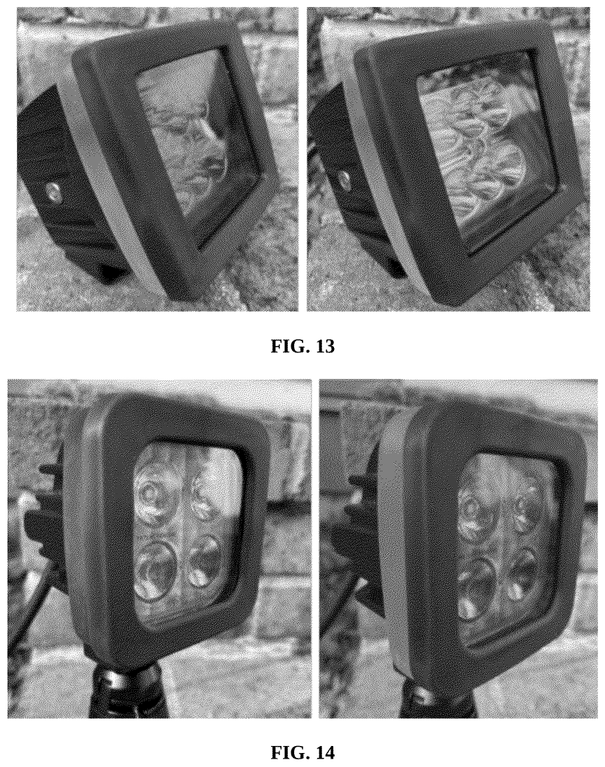

FIG. 13 illustrates two exemplary three inch (3″) light covers.

FIG. 14 illustrates two 2.75″ light covers with lens.

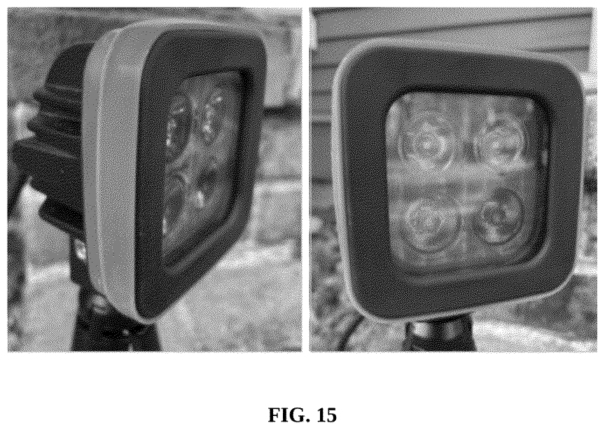

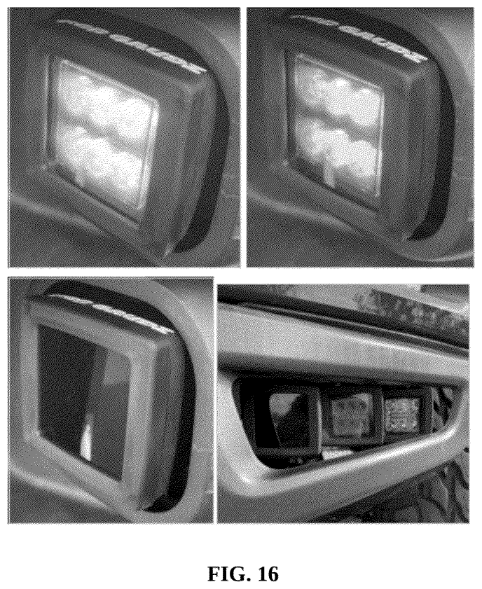

FIG. 15 illustrates two bands installed on two 2.75″ lights.

FIG. 16 illustrates light covers with various lens installed.

For many drivers, auxiliary driving lights are generally used to enhance visibility for vehicles by providing long-range illumination. They supplement and/or replace the high beam of standard headlamp systems and increase visibility and conspicuity to oncoming traffic. However, these lights are susceptible to damage from flying debris, which can impair their functionality and reduce their lifespan.

In some embodiments, the techniques described herein relate to a light protection system for a vehicle, including: a light protector configured to protect auxiliary driving lights, wherein the light protector includes a removable semi-flexible auxiliary light protector, a removable lens, and a removable flexible band; the auxiliary driving lights configured to provide additional illumination; the vehicle configured to use the auxiliary driving lights and the light protector; a standard headlamp system configured to provide primary illumination, supplemented and/or replaced by the auxiliary driving lights; wherein the light protector is configured to protect the auxiliary driving lights from flying debris.

According to some aspects, the techniques described herein relate to a light protection system, wherein the removable semi-flexible auxiliary light protector is sized to fit over and about a perimeter of an auxiliary light.

In some embodiments, the techniques described herein relate to a light protection system, wherein the removable lens is sized to fit within the removable semi-flexible auxiliary light protector.

According to some aspects, the techniques described herein relate to a light protection system, wherein the removable lens is made from materials including transparent polymers such as polycarbonate, acrylic, or polyethylene terephthalate, and glasses such as tempered glass or laminated glass.

In some embodiments, the techniques described herein relate to a light protection system, wherein the removable flexible band is used to secure the protector in place.

According to some aspects, the techniques described herein relate to a light protection system, wherein the vehicle is mounted with the light protector, and the light protector is specifically adapted to the contour and design of the vehicle's body to provide a seamless aesthetic integration while ensuring the auxiliary driving lights are adequately shielded.

In some embodiments, the techniques described herein relate to a light protection system, wherein the auxiliary light is covered by the removable semi-flexible auxiliary light protector, which is made from a durable, impact-resistant material capable of withstanding harsh environmental conditions and providing a reliable barrier against debris.

According to some aspects, the techniques described herein relate to a method of protecting auxiliary lights on a vehicle, including: providing a light protector including a removable semi-flexible auxiliary light protector, a removable lens, and a removable flexible band; mounting the light protector on the auxiliary lights of the vehicle; using the auxiliary lights to provide additional illumination; using a standard headlamp system to provide primary illumination, supplemented and/or replaced by the auxiliary lights; protecting the auxiliary lights from flying debris using the light protector.

In some embodiments, the techniques described herein relate to a method, wherein the removable semi-flexible auxiliary light protector is sized to fit over and about a perimeter of an auxiliary light.

According to some aspects, the techniques described herein relate to a method, wherein the removable lens is sized to fit within the removable semi-flexible auxiliary light protector.

In some embodiments, the techniques described herein relate to a method, wherein the removable flexible band is used to secure the protector in place.

According to some aspects, the techniques described herein relate to a method, wherein the auxiliary light is covered by the removable semi-flexible auxiliary light protector.

In some embodiments, the techniques described herein relate to a method, further including the step of adjusting the position of the light protector on the auxiliary lights.

According to some aspects, the techniques described herein relate to a method, further including the step of replacing the removable semi-flexible auxiliary light protector in the light protector.

In some embodiments, the techniques described herein relate to a method, further including the step of replacing the removable flexible band in the light protector.

According to some aspects, the techniques described herein relate to a method, further including the step of adjusting the tightness of the removable flexible band on the light protector; whereby differing diameters and flexible band sizes measured by their circumference that can be used to ensure proper elasticity on various sized light protectors and/or light covers.

In some embodiments, the techniques described herein relate to a method of making a light protection system for a vehicle, including: fabricating a removable semi-flexible auxiliary light protector; forming a removable lens to fit within the removable semi-flexible auxiliary light protector; producing a removable flexible band to secure the light protector; and assembling the light protector by attaching the removable lens and the removable flexible band to the removable semi-flexible auxiliary light protector.

According to some aspects, the techniques described herein relate to a method, wherein the fabricating of the removable semi-flexible auxiliary light protector includes using a material that is durable and impact-resistant.

In some embodiments, the techniques described herein relate to a method, wherein the forming of the removable lens includes shaping the lens to provide an optimal balance between light transmission and protection from debris.

According to some aspects, the techniques described herein relate to a method, wherein the producing of the removable flexible band includes selecting a material that provides sufficient elasticity to maintain a secure fit while allowing for easy removal and replacement.

In accordance with embodiments discussed herein, a light protection system for a vehicle is provided, comprising a light protector designed to shield auxiliary driving lights. The light protector includes a removable semi-flexible auxiliary light protector, a removable lens, and a removable flexible band. The auxiliary driving lights are configured to offer additional illumination, while a standard headlamp system provides primary illumination. The light protector is specifically configured to defend the auxiliary lights against flying debris. In other embodiments, a method of protecting auxiliary lights on a vehicle is provided, involving the use of a light protector with similar components as the system. The method includes mounting the light protector on the vehicle's auxiliary lights, using the lights for additional illumination, and protecting them from debris. Further embodiments include a method of making a light protection system for a vehicle, which involves fabricating the removable semi-flexible auxiliary light protector, forming the removable lens, producing the removable flexible band, and assembling these components into the light protector.

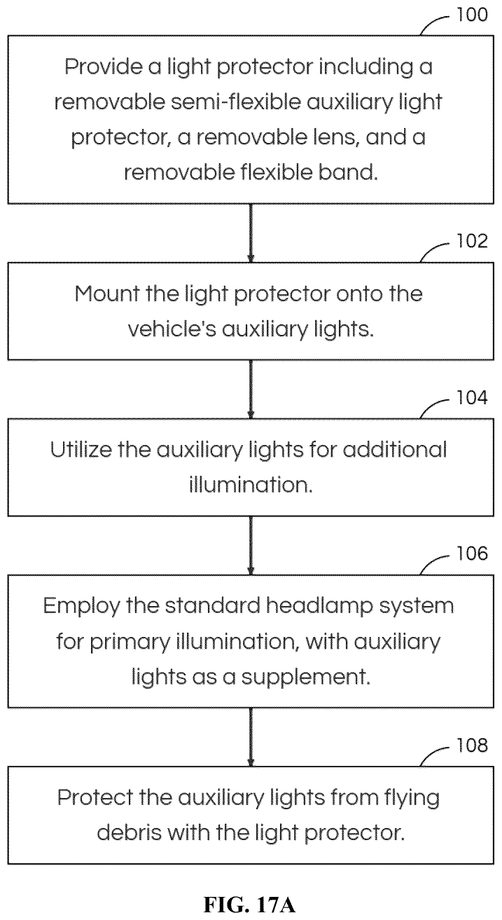

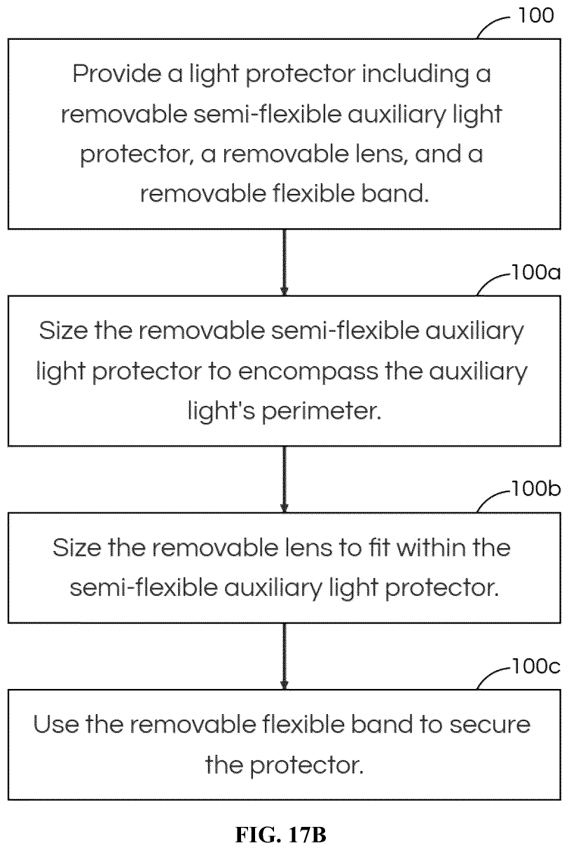

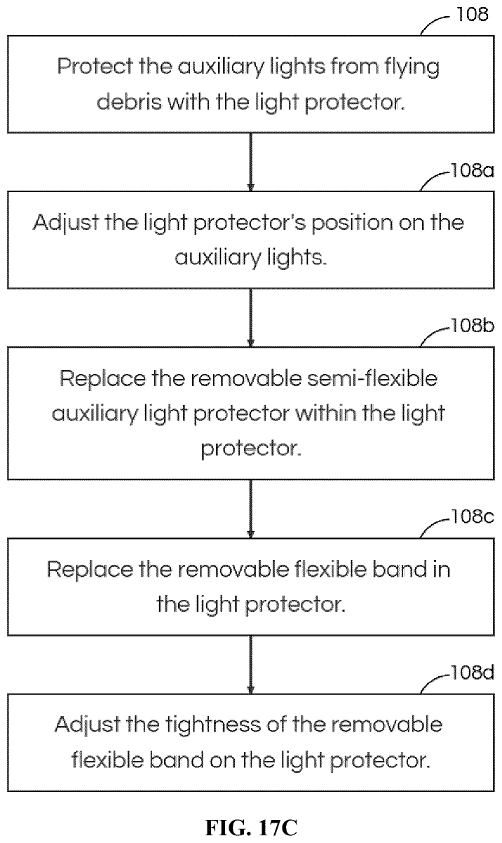

Referring now to FIG. 17A, in step 100, the process begins with providing a light protector that comprises a removable semi-flexible auxiliary light protector, a removable lens, and a removable flexible band. FIG. 17A depicts a process for enhancing vehicle lighting and safeguarding auxiliary lights. The light protector is designed to protect auxiliary driving lights from flying debris, ensuring the auxiliary lights remain functional and undamaged. The light protector is configured to protect auxiliary driving lights, which are designed to provide additional illumination by enhancing the visibility of distant objects, supplementing (or replacing) the high beam of a standard headlamp system, and increasing the vehicle's visibility and conspicuity to oncoming traffic.

In FIG. 17B, sub-step 100-a involves the removable semi-flexible auxiliary light protector, which is sized to fit over and about a perimeter of an auxiliary light. This ensures a secure attachment and coverage of the auxiliary light, protecting it from external elements and impacts. FIG. 17B illustrates the detailed sizing and securing process for light protector components. The removable semi-flexible auxiliary light protector is made from a durable, impact-resistant material capable of withstanding harsh environmental conditions and providing a reliable barrier against debris. This protector is used to cover the auxiliary light, ensuring it remains shielded from flying debris and potential damage. Sub-step 100-b focuses on the removable lens, which is sized to fit within the removable semi-flexible auxiliary light protector. This ensures compatibility and proper fitting with the light protector, providing effective protection and aesthetic integration. The removable lens is made from materials including transparent polymers such as polycarbonate, acrylic, or polyethylene terephthalate, and glasses such as tempered glass or laminated glass. The lens is shaped to provide an optimal balance between light transmission and protection from debris, ensuring that the auxiliary lights can still provide additional illumination while being protected.

Sub-step 100-c (FIG. 17B) addresses the removable flexible band, which is used to secure the protector in place. The band ensures that the light protector remains attached to the auxiliary light, maintaining its protective function. The removable flexible band is produced by selecting a material that provides sufficient elasticity to maintain a secure fit while allowing for easy removal and replacement. This band is for ensuring the light protector stays in place, even under harsh conditions. Overall, step 100 and its sub-steps detail the components and their attributes that make up the light protector system. The removable semi-flexible auxiliary light protector, the removable lens, and the removable flexible band work together to provide a solution for protecting auxiliary driving lights, enhancing their functionality, and ensuring they remain effective in providing additional illumination.

In step 100-a, the focus is on the removable semi-flexible auxiliary light protector. This component is designed to fit over and about the perimeter of an auxiliary light. The removable semi-flexible auxiliary light protector is a part of the light protection system, as it ensures a secure attachment and coverage of the auxiliary light. This protector is made from a durable, impact-resistant material capable of withstanding harsh environmental conditions and providing a reliable barrier against debris. The purpose of using this protector is to cover and protect the auxiliary light from flying debris and damage, ensuring the auxiliary lights remain functional and effective. The removable semi-flexible auxiliary light protector is sized to fit over and about a perimeter of an auxiliary light, which is for providing a secure fit that protects the auxiliary light from external elements and debris. This sizing ensures that the protector can adequately shield the auxiliary lights from flying debris, which could otherwise damage the lights and impair their function. The protector is also designed to add a design feature to the vehicle, enhancing its aesthetic appeal when mounted. The removable semi-flexible auxiliary light protector is used to cover the auxiliary light, providing protection and potentially adding a design feature to the vehicle it is mounted on. The protector is part of a light protection system that includes a removable lens and a removable flexible band, all working together to protect and enhance the functionality of the auxiliary lights. The light protector, comprising these components, is designed to shield the auxiliary lights from flying debris, ensuring they remain functional and effective in providing additional illumination and enhancing the vehicle's visibility and safety.

In sub-step 100-b, the focus is on the removable lens, which is a component of the light protection system. The removable lens is sized to fit within the removable semi-flexible auxiliary light protector. This precise sizing ensures compatibility and proper fitting with the light protector, which is for effective protection and aesthetic integration. The removable lens is made from materials including transparent polymers such as polycarbonate, acrylic, or polyethylene terephthalate, and glasses such as tempered glass or laminated glass. These materials are chosen for their durability and ability to provide an optimal balance between light transmission and protection from debris. The lens must allow sufficient light to pass through to ensure the auxiliary driving lights can perform their function of enhancing visibility while also protecting the lights from potential damage caused by flying debris.

The purpose of the removable lens being sized to fit within the removable semi-flexible auxiliary light protector is to ensure compatibility and proper fit for effective protection and aesthetic integration. This design consideration is for maintaining the integrity of the light protection system and ensuring that the auxiliary driving lights are adequately shielded while still providing the necessary illumination. The removable lens is an integral part of the light protector, which comprises a removable semi-flexible auxiliary light protector, a removable lens, and a removable flexible band.

The light protector is designed to protect the auxiliary driving lights from flying debris, thereby preventing damage and ensuring the lights' functionality. The removable lens, by fitting snugly within the semi-flexible protector, contributes to the overall effectiveness of the light protection system. The removable lens's material properties, such as being made from transparent polymers or glasses, further enhance its functionality by providing a clear, durable barrier that does not impede the light output of the auxiliary driving lights. This balance between protection and light transmission is for the system's performance, ensuring that the vehicle's visibility and safety are not compromised. Overall, sub-step 100-b highlights the importance of the removable lens's precise sizing and material composition in the light protection system, ensuring that the auxiliary driving lights are both protected and functional.

In step 100-c (FIG. 17B), the removable flexible band is used to secure the protector in place. The removable flexible band is a component of the light protection system, ensuring that the light protector remains securely attached to the auxiliary light. This band is designed to provide sufficient elasticity to maintain a secure fit while allowing for easy removal and replacement. The purpose of the removable flexible band is to ensure that the light protector remains securely attached to the auxiliary light, maintaining its protective function. The removable flexible band is used to secure the protector in place, ensuring that the light protector remains attached to the auxiliary light. This is for the proper functioning of the light protection system, as it prevents the protector from becoming dislodged during vehicle operation. The band is designed to be both flexible and durable, capable of withstanding the rigors of vehicle use while providing a reliable means of securing the light protector.

The removable flexible band is produced by selecting a material that provides sufficient elasticity to maintain a secure fit while allowing for easy removal and replacement. This ensures that the band can be easily adjusted or replaced as needed, without compromising the security of the light protector. The band is an integral part of the light protection system, working in conjunction with the removable semi-flexible auxiliary light protector and the removable lens to provide protection for the auxiliary driving lights. In summary, the removable flexible band is a component of the light protection system, used to secure the protector in place and ensure that the auxiliary lights are shielded from flying debris and other potential hazards. The band is designed to be both flexible and durable, providing a reliable means of securing the light protector while allowing for easy adjustment and replacement.

Turning attention back to FIG. 17A, in step 102, the process involves mounting the light protector on the auxiliary lights of the vehicle. The light protector is designed to protect the auxiliary driving lights from flying debris and comprises a removable semi-flexible auxiliary light protector, a removable lens, and a removable flexible band. The light protector is configured to protect auxiliary driving lights, which are designed to provide relatively long-range illumination forward of an automobile, motorcycle, electric bicycle, recreational vehicle, buses, and trucks. These auxiliary driving lights enhance the visibility of distant objects and are intended to supplement and/or to replace the high beam of a standard headlamp system, thereby increasing the vehicle's visibility and conspicuity to oncoming traffic.

The removable semi-flexible auxiliary light protector is sized to fit over and about a perimeter of an auxiliary light, ensuring secure attachment and coverage of the auxiliary light. This protector is made from a durable, impact-resistant material capable of withstanding harsh environmental conditions and providing a reliable barrier against debris.

The removable lens is sized to fit within the removable semi-flexible auxiliary light protector, ensuring compatibility and proper fitting with the light protector. The lens is made from materials including transparent polymers such as polycarbonate, acrylic, or polyethylene terephthalate, and glasses such as tempered glass or laminated glass. These materials are chosen to provide an optimal balance between light transmission and protection from debris. The removable flexible band is used to secure the protector in place, ensuring that the light protector remains attached to the auxiliary light. This band is selected for its sufficient elasticity to maintain a secure fit while allowing for easy removal and replacement. The light protector, when mounted on the vehicle, is adapted to the contour and design of the vehicle's body to provide a seamless aesthetic integration while ensuring the auxiliary driving lights are shielded. In summary, step 102 involves the action of mounting the light protector on the auxiliary lights of the vehicle, ensuring that the auxiliary lights are protected from flying debris while maintaining their functionality and enhancing the vehicle's aesthetic appeal.

In step 104 (FIG. 17A), the focus is on using the auxiliary lights to provide additional illumination. The auxiliary driving lights are designed to provide relatively long-range illumination forward of an automobile, motorcycle, recreational vehicle, buses, and trucks, which enhance the visibility of distant objects. These lights are intended to supplement or replace the high beam of a standard headlamp system and to increase the vehicle's visibility and conspicuity to oncoming traffic. The auxiliary driving lights enhance the visibility of distant objects for the driver, improve safety and prevent accidents, improve safety and driving conditions, and increase the vehicle's visibility and conspicuity to oncoming traffic. The auxiliary driving lights are configured to provide additional illumination, which is for enhancing the visibility of distant objects by providing additional long-range illumination. This is particularly useful in poorly lit conditions or during night driving. The auxiliary driving lights supplement and/or replace the high beam of the standard headlamp system, thereby improving the vehicle's visibility and safety, especially for oncoming traffic. This increased visibility and conspicuity help in reducing the risk of accidents by making the vehicle more noticeable to other drivers. The auxiliary driving lights are a part of the vehicle's lighting system, designed to work in conjunction with the standard headlamp system. The standard headlamp system is configured to provide primary illumination, supplemented or replaced by the auxiliary driving lights. This combination ensures that the vehicle has optimal lighting for various driving conditions, enhancing overall safety and driving experience. In summary, step 104 involves the use of auxiliary driving lights to provide additional illumination, enhancing the visibility of distant objects, improving safety, and increasing the vehicle's visibility and conspicuity to oncoming traffic. The auxiliary driving lights work in conjunction with the standard headlamp system to provide a lighting solution for the vehicle.

In some embodiments, in step 106 of FIG. 17A, any of the auxiliary lights disclosed herein can also replace a standard headlamp all together. For example, this can be seen on motorcycles, electric bicycles, or cars. Auxiliary lights can, according to some aspects, supplement and/or replace both high and low beam vehicle lighting and can be used in place of standard headlamp systems for both high and low beam. In some embodiments, in step 106 of FIG. 17A, the focus is on using a standard headlamp system to provide primary illumination, supplemented or replaced by the auxiliary lights. The standard headlamp system is configured to provide primary illumination, supplemented or replaced by the auxiliary driving lights. The auxiliary driving lights are designed to enhance the visibility of distant objects by providing additional long-range illumination forward of an automobile, motorcycle, recreational vehicle, buses, and trucks. This enhancement is particularly useful in poorly lit conditions or during night driving. The auxiliary driving lights are intended to supplement or replace the high beam of a standard headlamp system and to increase the vehicle's visibility and conspicuity to oncoming traffic, thereby improving safety and preventing accidents. The standard headlamp system, in conjunction with the auxiliary driving lights, ensures that the vehicle has a lighting system that improves overall safety and driving conditions. The auxiliary driving lights, by supplementing or replacing the high beam, provide relatively long-range illumination forward, which is for the driver to see distant objects clearly. This setup increases the vehicle's visibility and conspicuity to oncoming traffic, making the vehicle more noticeable and reducing the risk of accidents.

The auxiliary driving lights are designed to provide relatively long-range illumination forward of an automobile, motorcycle, recreational vehicle, buses, and trucks, which enhance the visibility of distant objects. They are intended to supplement or replace the high beam of a standard headlamp system and to increase the vehicle's visibility and conspicuity to oncoming traffic. This dual lighting system ensures that the vehicle is well-lit and visible in various driving conditions, thereby enhancing safety and preventing accidents.

In step 108 (FIG. 17A), the primary action is protecting the auxiliary lights from flying debris using the light protector. The light protector is configured to protect auxiliary driving lights, which are designed to provide relatively long-range illumination forward of an automobile, motorcycle, recreational vehicle, buses, and trucks, enhancing the visibility of distant objects. The auxiliary driving lights supplement or replace the high beam of a standard headlamp system and increase the vehicle's visibility and conspicuity to oncoming traffic. The light protector comprises a removable semi-flexible auxiliary light protector, a removable lens, and a removable flexible band. The removable semi-flexible auxiliary light protector is used to cover the auxiliary light and is made from a durable, impact-resistant material capable of withstanding harsh environmental conditions and providing a reliable barrier against debris. This protector is sized to fit over and about a perimeter of an auxiliary light, ensuring secure attachment and coverage of the auxiliary light. The removable lens is sized to fit within the removable semi-flexible auxiliary light protector, ensuring compatibility and proper fitting with the light protector. The lens is made from materials including transparent polymers such as polycarbonate, acrylic, or polyethylene terephthalate, and glasses such as tempered glass or laminated glass.

The lens is shaped to provide an optimal balance between light transmission and protection from debris. The removable flexible band is used to secure the protector in place, ensuring that the light protector remains attached to the auxiliary light. The band is produced from a material that provides sufficient elasticity to maintain a secure fit while allowing for easy removal and replacement.

Turning attention now to FIG. 17C, sub-step 108-a involves adjusting the position of the light protector on the auxiliary lights. This ensures that the light protector is correctly aligned and provides optimal protection. Sub-step 108-b involves replacing the removable semi-flexible auxiliary light protector in the light protector. This step is necessary when the existing protector is damaged or worn out, ensuring continuous protection of the auxiliary lights. Sub-step 108-c involves replacing the removable flexible band in the light protector. Similar to the previous sub-step, this ensures that the light protector remains securely attached to the auxiliary light. Sub-step 108-d involves adjusting the tightness of the removable flexible band on the light protector; whereby differing diameters and flexible band sizes measured by their circumference that can be used to ensure proper elasticity on various sized light protectors and/or light covers. This step ensures that the band is neither too loose nor too tight, maintaining the secure attachment of the light protector while allowing for easy removal and replacement. Overall, the light protector system is designed to protect the auxiliary driving lights from flying debris, ensuring their functionality and enhancing the vehicle's visibility and safety. The system is adaptable, allowing for adjustments and replacements to maintain protection and performance.

In step 108-a, the action involves adjusting the position of the light protector on the auxiliary lights. The light protector is configured to protect auxiliary driving lights from flying debris, comprising a removable semi-flexible auxiliary light protector, a removable lens, and a removable flexible band. The light protector is designed to shield the auxiliary lights from external elements and impacts, ensuring the auxiliary lights remain functional and undamaged. The removable semi-flexible auxiliary light protector is sized to fit over and about a perimeter of an auxiliary light. This ensures a secure attachment and coverage of the auxiliary light, providing a reliable barrier against debris. The material used for the removable semi-flexible auxiliary light protector is durable and impact-resistant, capable of withstanding harsh environmental conditions and providing a reliable barrier against debris. This protector is for maintaining the integrity of the auxiliary lights, especially in adverse conditions. The removable lens is sized to fit within the removable semi-flexible auxiliary light protector, ensuring compatibility and proper fitting with the light protector.

The lens is made from materials including transparent polymers such as polycarbonate, acrylic, or polyethylene terephthalate, and glasses such as tempered glass or laminated glass. These materials are chosen to provide an optimal balance between light transmission and protection from debris, ensuring that the auxiliary lights can still function effectively while being protected. The removable flexible band is used to secure the protector in place, ensuring that the light protector remains attached to the auxiliary light. The band is selected for its sufficient elasticity to maintain a secure fit while allowing for easy removal and replacement. This flexibility is for adjusting the tightness of the band to ensure the protector is firmly in place, providing consistent protection. Adjusting the position of the light protector on the auxiliary lights involves ensuring that the protector is correctly aligned and securely attached to provide maximum protection. This step is for maintaining the effectiveness of the light protector, as any misalignment could compromise the protection offered to the auxiliary lights.

In some embodiments, the light protector or the light cover serves a functional purpose for a “sealed beam” LED. For example, for lights where the light is manufactured in one color, and without light protector or cover there is no way to change the output color of the light itself unless colored film is applied directly to the face of the light. In this example, the light cover or protector can be utilized for multiple functions such as changing output color, protection, and enhancing appeal. In some embodiments, the light protector not only serves a functional purpose but also adds a design feature to the vehicle, enhancing its aesthetic appeal while ensuring the auxiliary driving lights are shielded. In summary, step 108-a involves a process of adjusting the light protector to ensure it is securely and correctly positioned on the auxiliary lights. This process includes ensuring the removable semi-flexible auxiliary light protector fits over the auxiliary light, the removable lens fits within the protector, and the removable flexible band secures the protector in place. The materials and design of these components are chosen to provide protection and functionality, ensuring the auxiliary lights remain protected from debris and other external elements.

In sub-step 108-b (FIG. 17C), the focus is on replacing the removable semi-flexible auxiliary light protector in the light protector. The removable semi-flexible auxiliary light protector is a component designed to cover and protect the auxiliary light from flying debris and damage. This protector is made from a durable, impact-resistant material capable of withstanding harsh environmental conditions and providing a reliable barrier against debris. The protector is sized to fit over and about a perimeter of an auxiliary light, ensuring a secure attachment and coverage of the auxiliary light. This fitting is to protect the auxiliary lights from external elements and impacts. The light protector, which includes the removable semi-flexible auxiliary light protector, a removable lens, and a removable flexible band, is configured to protect auxiliary driving lights. The light protector is designed to prevent damage to the auxiliary lights and to protect and enhance their functionality.

The removable semi-flexible auxiliary light protector is used to cover the auxiliary light, ensuring it remains shielded from flying debris. The process of replacing the removable semi-flexible auxiliary light protector involves ensuring that the new protector fits securely over the auxiliary light, maintaining the protective function of the light protector. This replacement is to ensure the continued protection of the auxiliary lights, which are designed to provide relatively long-range illumination forward of a vehicle, enhancing the visibility of distant objects and increasing the vehicle's visibility and conspicuity to oncoming traffic. In summary, sub-step 108-b involves the task of replacing the removable semi-flexible auxiliary light protector to maintain the protective function of the light protector, ensuring the auxiliary lights remain shielded from debris and continue to provide enhanced visibility and safety for the vehicle.

In step 108-c (FIG. 17C), the focus is on replacing the removable flexible band in the light protector. The removable flexible band is a component of the light protection system, as it is used to secure the protector in place. This ensures that the light protector remains attached to the auxiliary light, maintaining its protective function. The removable flexible band is designed to provide sufficient elasticity to maintain a secure fit while allowing for easy removal and replacement. This feature is for the practical use and maintenance of the light protection system, as it allows for quick adjustments and replacements without compromising the security of the attachment. The removable flexible band is part of a light protection system that includes a removable semi-flexible auxiliary light protector and a removable lens.

The light protector is configured to protect auxiliary driving lights from flying debris, which could otherwise damage the lights and impair their function. The auxiliary driving lights are designed to provide relatively long-range illumination forward of a vehicle, enhancing the visibility of distant objects and increasing the vehicle's visibility and conspicuity to oncoming traffic. This is particularly useful in poorly lit conditions or during night driving, as it supplements or replaces the high beam of a standard headlamp system. The removable semi-flexible auxiliary light protector is sized to fit over and about the perimeter of an auxiliary light, ensuring a secure attachment and coverage.

It is made from a durable, impact-resistant material capable of withstanding harsh environmental conditions and providing a reliable barrier against debris. The removable lens, which is sized to fit within the removable semi-flexible auxiliary light protector, is made from materials including transparent polymers such as polycarbonate, acrylic, or polyethylene terephthalate, and glasses such as tempered glass or laminated glass. This ensures compatibility and proper fitting with the light protector, providing an optimal balance between light transmission and protection from debris. The light protector is adapted to the contour and design of the vehicle's body to provide a seamless aesthetic integration while ensuring the auxiliary driving lights are shielded. This adds a design feature to the vehicle, enhancing its aesthetic appeal. The light protector can be adjusted in position on the auxiliary lights, and the tightness of the removable flexible band can be adjusted to ensure a secure fit. In summary, step 108-c involves the replacement of the removable flexible band, which is for maintaining the protective function of the light protector. The band's elasticity allows for easy removal and replacement, ensuring that the light protector remains securely attached to the auxiliary light, thereby protecting it from flying debris and enhancing the vehicle's visibility and safety.

In step 108-d (FIG. 17C), the focus is on adjusting the tightness of the removable flexible band on the light protector. In some embodiments, the removeable flexible band on the light protector is a place for etching brand names, and business logo, or slogans. In some embodiments, the removable flexible band is used to secure the protector in place, ensuring that the light protector remains attached to the auxiliary light. This band is for maintaining the protective function of the light protector, which shields the auxiliary lights from flying debris and other external elements. The removable flexible band is described as having sufficient elasticity to maintain a secure fit while allowing for easy removal and replacement. This elasticity is for the band to adapt to different sizes and shapes of auxiliary lights, providing a snug fit that prevents the protector from dislodging during vehicle operation. The band must be adjusted to the correct tightness to ensure that the light protector is firmly held in place without causing damage to the auxiliary lights or the light protector itself.

The light protector, comprising a removable semi-flexible auxiliary light protector, a removable lens, and the removable flexible band, is designed to protect the auxiliary driving lights from flying debris. The removable semi-flexible auxiliary light protector is made from a durable, impact-resistant material capable of withstanding harsh environmental conditions, providing a reliable barrier against debris. The removable lens, which fits within the semi-flexible auxiliary light protector, is made from materials including transparent polymers such as polycarbonate, acrylic, or polyethylene terephthalate, and glasses such as tempered glass or laminated glass. This lens ensures compatibility and proper fitting with the light protector, offering an optimal balance between light transmission and protection from debris. The auxiliary driving lights are designed to provide relatively long-range illumination forward of a vehicle, enhancing the visibility of distant objects.

These lights supplement and/or can replace the high beam of a standard headlamp system, increasing the vehicle's visibility and conspicuity to oncoming traffic. The light protector is adapted to the contour and design of the vehicle's body, providing a seamless aesthetic integration while ensuring the auxiliary driving lights are shielded. In summary, adjusting the tightness of the removable flexible band on the light protector is a step to ensure the secure attachment and effective protection of the auxiliary driving lights. The band's elasticity and the overall design of the light protector contribute to the system's functionality, enhancing both the safety and aesthetic appeal of the vehicle.

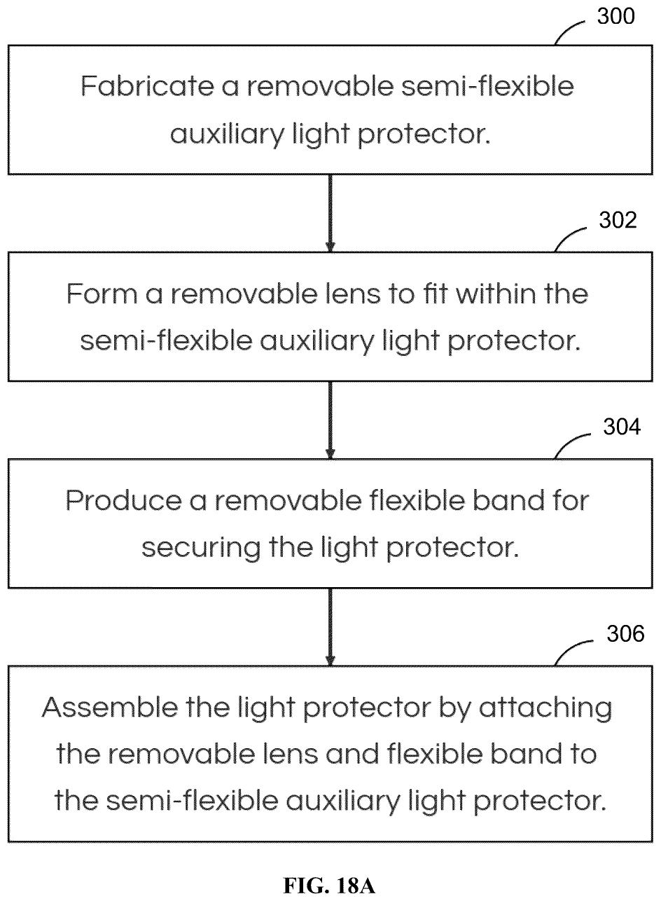

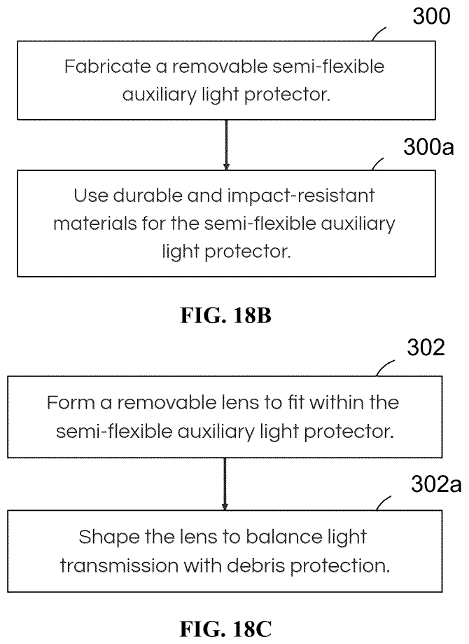

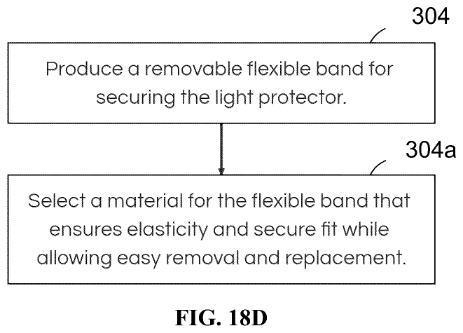

FIG. 18A outlines the fabrication and assembly of a vehicle light protector. In step 300 of FIG. 18A, the process involves fabricating a removable semi-flexible auxiliary light protector. This step is for creating a component that will shield the auxiliary driving lights from damage caused by flying debris and harsh environmental conditions. The removable semi-flexible auxiliary light protector is designed to be durable and impact-resistant, ensuring it can withstand various external elements. This protector is sized to fit over and about the perimeter of an auxiliary light, providing a secure fit that covers and protects the auxiliary light from potential damage.

In FIG. 18B, sub-step 300-a further elaborates on the material selection for the removable semi-flexible auxiliary light protector. The material used must be durable and impact-resistant, capable of withstanding harsh environmental conditions and providing a reliable barrier against debris. This ensures that the auxiliary lights remain protected and functional, even in challenging conditions. The removable semi-flexible auxiliary light protector is a component of the light protection system, which also includes a removable lens and a removable flexible band. The light protector as a whole is designed to protect the auxiliary driving lights, which are configured to provide additional illumination by enhancing the visibility of distant objects, supplementing or replacing the high beam of a standard headlamp system, and increasing the vehicle's visibility and conspicuity to oncoming traffic.

The light protector is mounted on the vehicle and is adapted to the contour and design of the vehicle's body to provide a seamless aesthetic integration while ensuring the auxiliary driving lights are shielded. This integration not only protects the auxiliary lights but also adds a design feature to the vehicle, enhancing its overall appearance. In summary, step 300 involves the fabrication of a removable semi-flexible auxiliary light protector using a durable and impact-resistant material. This protector is for shielding the auxiliary driving lights from debris and environmental damage, ensuring they remain functional and effective in providing additional illumination and enhancing vehicle safety.

In step 300-a (FIG. 18B), the focus is on the removable semi-flexible auxiliary light protector, specifically on the material used for its fabrication. The removable semi-flexible auxiliary light protector is a component of the light protection system, designed to cover and protect the auxiliary lights from flying debris and damage. The material used for this protector is described as durable and impact-resistant, capable of withstanding harsh environmental conditions and providing a reliable barrier against debris. This ensures that the auxiliary lights remain functional and undamaged, even in challenging conditions. The removable semi-flexible auxiliary light protector is sized to fit over and about the perimeter of an auxiliary light, ensuring a secure attachment and coverage. This fitting is for the protector to effectively shield the auxiliary lights from external elements and impacts. The protector's semi-flexible nature allows it to conform to the shape of the auxiliary light, providing a snug fit that enhances its protective capabilities.

The purpose of using a durable and impact-resistant material for the removable semi-flexible auxiliary light protector is to ensure that it can withstand the rigors of everyday use, including exposure to flying debris, harsh weather conditions, and potential impacts. This material selection is for maintaining the integrity and functionality of the auxiliary lights, which are designed to provide additional long-range illumination and enhance the vehicle's visibility and safety. In summary, step 300-a involves the use of a durable and impact-resistant material for fabricating the removable semi-flexible auxiliary light protector. This material choice is for ensuring the protector's effectiveness in shielding the auxiliary lights from damage, thereby maintaining their functionality and enhancing the vehicle's overall safety and visibility.

Turning attention back to FIG. 18A, in step 302, the process involves forming a removable lens to fit within the removable semi-flexible auxiliary light protector. This step is for ensuring that the lens is compatible with the light protector and can provide the necessary protection and functionality. The removable lens is sized to fit within the removable semi-flexible auxiliary light protector. This ensures compatibility and proper fitting with the light protector, which is for effective protection and aesthetic integration. The lens is shaped to provide an optimal balance between light transmission and protection from debris. This balance is as it allows the lens to protect the auxiliary lights from flying debris while still allowing sufficient light to pass through for illumination purposes.

The materials used for the removable lens include transparent polymers such as polycarbonate, acrylic, or polyethylene terephthalate, and glasses such as tempered glass or laminated glass. These materials are chosen for their durability and ability to withstand harsh environmental conditions while maintaining clarity for light transmission. The purpose of the removable lens being sized to fit within the removable semi-flexible auxiliary light protector is to ensure compatibility and proper fit for effective protection and aesthetic integration. This step is part of the overall process of fabricating a light protection system for a vehicle, which includes fabricating a removable semi-flexible auxiliary light protector, forming a removable lens, producing a removable flexible band, and assembling the light protector by attaching the removable lens and the removable flexible band to the removable semi-flexible auxiliary light protector. In summary, step 302 involves the precise formation of a removable lens that fits within the removable semi-flexible auxiliary light protector, using materials that provide an optimal balance between light transmission and protection from debris. This step is for ensuring the functionality and effectiveness of the light protection system.

In FIG. 18C, in step 302-a, the process involves shaping the removable lens to provide an optimal balance between light transmission and protection from debris. The removable lens is a component of the light protector system, which is designed to fit within the removable semi-flexible auxiliary light protector. This lens is made from materials including transparent polymers such as polycarbonate, acrylic, or polyethylene terephthalate, and glasses such as tempered glass or laminated glass. The purpose of the removable lens being sized to fit within the removable semi-flexible auxiliary light protector is to ensure compatibility and proper fitting with the light protector, thereby providing effective protection and aesthetic integration.

The shaping of the lens is to achieve an optimal balance between light transmission and protection from debris. This balance is because the lens must allow sufficient light to pass through to enhance the visibility of distant objects while also being robust enough to shield the auxiliary lights from flying debris. The auxiliary driving lights, which the lens protects, are designed to provide relatively long-range illumination forward of an automobile, motorcycle, recreational vehicle, buses, and trucks. These lights enhance the visibility of distant objects, supplement and/or can replace the high beam of a standard headlamp system, and increase the vehicle's visibility and conspicuity to oncoming traffic. The light protector, comprising the removable semi-flexible auxiliary light protector, the removable lens, and the removable flexible band, is configured to protect the auxiliary driving lights from flying debris. The removable semi-flexible auxiliary light protector is made from a durable, impact-resistant material capable of withstanding harsh environmental conditions and providing a reliable barrier against debris. This protector is sized to fit over and about the perimeter of an auxiliary light, ensuring a secure attachment and coverage of the auxiliary light. The removable flexible band is used to secure the protector in place, ensuring that the light protector remains attached to the auxiliary light. This band is selected for its sufficient elasticity to maintain a secure fit while allowing for easy removal and replacement.

The entire light protection system is designed to provide protection and potentially add a design feature to the vehicle it is mounted on, enhancing the aesthetic appeal of the vehicle while ensuring the auxiliary driving lights are shielded. In summary, step 302-a involves the precise shaping of the removable lens to ensure it provides an optimal balance between light transmission and protection from debris, fitting seamlessly within the removable semi-flexible auxiliary light protector, and contributing to the overall functionality and aesthetic integration of the light protection system.

Turning attention back to FIG. 18A, in step 304, the focus is on producing a removable flexible band to secure the light protector. The removable flexible band is a component of the light protection system, ensuring that the light protector remains securely attached to the auxiliary light, thereby maintaining its protective function. The removable flexible band is used to secure the protector in place, ensuring the light protector remains attached to the auxiliary light. This is for the light protector to effectively shield the auxiliary lights from flying debris and other external elements.

In sub-step 304-a, the material selection for the removable flexible band is emphasized. The material chosen must provide sufficient elasticity to maintain a secure fit while allowing for easy removal and replacement. This ensures that the band can be easily adjusted or replaced as needed without compromising the secure attachment of the light protector. The purpose of the removable flexible band is to ensure that the light protector remains securely attached to the auxiliary light, maintaining its protective function. The band must be durable and flexible enough to withstand the environmental conditions it will be exposed to, while also being easy to handle for installation and maintenance purposes. The removable flexible band is a part of the light protection system, which comprises a removable semi-flexible auxiliary light protector, a removable lens, and the removable flexible band itself. The light protector is designed to protect the auxiliary driving lights from flying debris, which could otherwise damage the lights and impair their function. The auxiliary driving lights are intended to supplement or replace the high beam of a standard headlamp system, providing additional long-range illumination and increasing the vehicle's visibility and conspicuity to oncoming traffic.

The light protector, including the removable flexible band, is adapted to the contour and design of the vehicle's body to provide a seamless aesthetic integration while ensuring the auxiliary driving lights are shielded. This design feature not only enhances the aesthetic appeal of the vehicle but also ensures that the auxiliary lights are protected from external elements and impacts. In summary, step 304 and sub-step 304-a detail the production and material selection of the removable flexible band, highlighting its importance in securing the light protector and maintaining the protective function of the auxiliary driving lights. The band must be elastic enough to ensure a secure fit while allowing for easy removal and replacement, contributing to the overall effectiveness and durability of the light protection system.

In FIG. 18D, in step 304-a, the focus is on the removable flexible band, which is a component of the light protection system. The removable flexible band is used to secure the light protector in place, ensuring that it remains attached to the auxiliary light. This step involves selecting a material that provides sufficient elasticity to maintain a secure fit while allowing for easy removal and replacement. The purpose of the removable flexible band is to ensure that the light protector remains securely attached to the auxiliary light, maintaining its protective function. The removable flexible band is described as being used to secure the protector in place, which is for the light protector to function effectively. The band must be made from a material that provides sufficient elasticity, which allows it to maintain a secure fit around the auxiliary light while also being easy to remove and replace when necessary. This ensures that the light protector can be easily maintained and adjusted as needed. The light protector, comprising a removable semi-flexible auxiliary light protector, a removable lens, and a removable flexible band, is designed to protect the auxiliary driving lights from flying debris. The auxiliary driving lights are intended to provide additional illumination, enhancing the visibility of distant objects and supplementing and/or replacing the high beam of a standard headlamp system. The light protector is adapted to the contour and design of the vehicle's body, providing a seamless aesthetic integration while ensuring the auxiliary driving lights are shielded. The removable semi-flexible auxiliary light protector is sized to fit over and about the perimeter of an auxiliary light, providing a secure fit that protects the auxiliary light from external elements and debris. The removable lens is sized to fit within the removable semi-flexible auxiliary light protector, ensuring compatibility and proper fitting with the light protector.

The removable lens is made from materials including transparent polymers such as polycarbonate, acrylic, or polyethylene terephthalate, and glasses such as tempered glass or laminated glass. These materials are chosen to provide an optimal balance between light transmission and protection from debris. The removable flexible band, therefore, plays a role in the overall functionality of the light protection system. By selecting a material that provides sufficient elasticity, the band ensures that the light protector remains securely attached to the auxiliary light, maintaining its protective function while allowing for easy removal and replacement. This combination of components and materials ensures that the light protection system effectively protects the auxiliary driving lights, enhances the vehicle's visibility and safety, and adds a design feature to the vehicle.

Turning focus back to FIG. 18A, in step 306, the process involves assembling the light protector by attaching the removable lens and the removable flexible band to the removable semi-flexible auxiliary light protector. This step is for ensuring that the light protector is fully functional and ready to be mounted on the auxiliary driving lights of a vehicle. The light protector, as described, is configured to protect auxiliary driving lights from flying debris. It comprises a removable semi-flexible auxiliary light protector, a removable lens, and a removable flexible band. The removable semi-flexible auxiliary light protector is designed to cover the auxiliary light, providing a durable and impact-resistant barrier capable of withstanding harsh environmental conditions.

This protector is sized to fit over and about the perimeter of an auxiliary light, ensuring a secure attachment and coverage of the auxiliary light. The removable lens is sized to fit within the removable semi-flexible auxiliary light protector. It is made from materials including transparent polymers such as polycarbonate, acrylic, or polyethylene terephthalate, and glasses such as tempered glass or laminated glass. The lens is shaped to provide an optimal balance between light transmission and protection from debris, ensuring compatibility and proper fitting with the light protector. The removable flexible band is used to secure the protector in place. It is produced from a material that provides sufficient elasticity to maintain a secure fit while allowing for easy removal and replacement. This band ensures that the light protector remains attached to the auxiliary light, maintaining its protective function. The auxiliary driving lights are designed to provide relatively long-range illumination forward of an automobile, motorcycle, recreational vehicle, buses, and truck, enhancing the visibility of distant objects. These lights are intended to supplement or replace the high beam of a standard headlamp system, increasing the vehicle's visibility and conspicuity to oncoming traffic.

The vehicle, configured to use the auxiliary driving lights and the light protector, benefits from the added protection and enhanced functionality provided by the light protector. The standard headlamp system provides primary illumination, supplemented or replaced by the auxiliary driving lights, to improve safety and driving conditions. In summary, step 306 involves the assembly of the light protector, ensuring that the removable lens and the removable flexible band are properly attached to the removable semi-flexible auxiliary light protector. This assembly process ensures that the light protector is ready to provide protection for the auxiliary driving lights, enhancing the vehicle's visibility and safety.

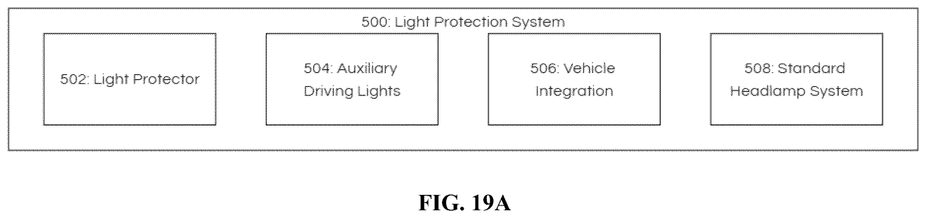

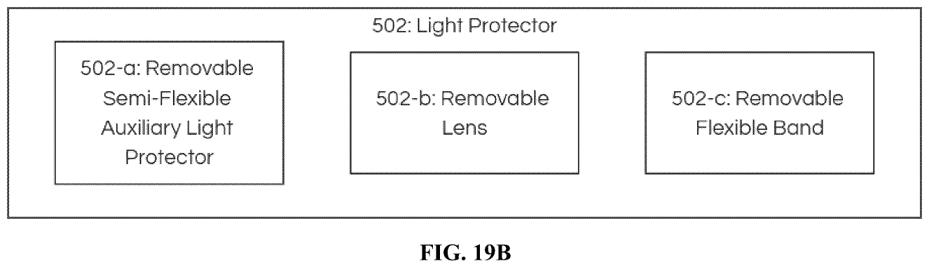

FIG. 19A depicts the components of a vehicle light protection system. In FIG. 19A, the light protection system, identified as system/component number 500, is designed to protect auxiliary driving lights on a vehicle. This system includes several key components: a light protector 502, auxiliary driving lights 504, a vehicle 506, and a standard headlamp system 508. Each of these components plays a role in ensuring the functionality and protection of the auxiliary driving lights. The light protector is configured to protect auxiliary driving lights from flying debris. It comprises a removable semi-flexible auxiliary light protector, a removable lens, and a removable flexible band. The removable semi-flexible auxiliary light protector is designed to cover the auxiliary light, providing a durable and impact-resistant barrier capable of withstanding harsh environmental conditions. This protector is sized to fit over and about the perimeter of an auxiliary light, ensuring secure attachment and coverage. The removable lens, which fits within the semi-flexible auxiliary light protector, is made from materials including transparent polymers such as polycarbonate, acrylic, or polyethylene terephthalate, and glasses such as tempered glass or laminated glass. This lens is shaped to provide an optimal balance between light transmission and protection from debris. The removable flexible band is used to secure the protector in place, ensuring that it remains attached to the auxiliary light. This band is made from a material that provides sufficient elasticity to maintain a secure fit while allowing for easy removal and replacement.

The auxiliary driving lights are designed to provide additional illumination, enhancing the visibility of distant objects by providing relatively long-range illumination forward of the vehicle. These lights are intended to supplement or to replace the high beam of a standard headlamp system, increasing the vehicle's visibility and conspicuity to oncoming traffic. The standard headlamp system provides primary illumination, which is supplemented or replaced by the auxiliary driving lights to improve safety and driving conditions, especially in poorly lit environments or during night driving. The vehicle is configured to use the auxiliary driving lights and the light protector. The light protector is adapted to the contour and design of the vehicle's body, providing a seamless aesthetic integration while ensuring the auxiliary driving lights are adequately shielded. This integration not only protects the auxiliary lights from damage but also adds a design feature to the vehicle. In summary, the light protection system (component 500) is a solution that includes a light protector with a removable semi-flexible auxiliary light protector, a removable lens, and a removable flexible band. These components work together to protect the auxiliary driving lights, which provide additional illumination and enhance the vehicle's visibility and safety. The system is designed to integrate seamlessly with the vehicle, ensuring both functionality and aesthetic appeal.

In FIG. 19B, the light protector, identified as component number 502, is a primary component designed to provide protection to auxiliary lights on a vehicle. FIG. 19B details the constituent elements of the Light Protector. This component is for ensuring the auxiliary driving lights remain functional and undamaged by external elements such as flying debris. The light protector comprises several sub-components, each with specific roles and attributes. The removable semi-flexible auxiliary light protector, sub-component number 502-a, is a key element of the light protector. It is designed to cover the auxiliary light, providing a durable and impact-resistant barrier against debris. This sub-component is sized to fit over and about the perimeter of an auxiliary light, ensuring a secure attachment and coverage. The material used for this protector is capable of withstanding harsh environmental conditions, providing a reliable barrier against debris.

The purpose of this sub-component is to protect the auxiliary lights from external elements and impacts, ensuring their functionality is not impaired. The removable lens, sub-component number 502-b, fits within the removable semi-flexible auxiliary light protector. This lens is made from materials including transparent polymers such as polycarbonate, acrylic, or polyethylene terephthalate, and glasses such as tempered glass or laminated glass. The lens is sized to fit within the semi-flexible protector to ensure compatibility and proper fitting. The purpose of the removable lens is to provide an optimal balance between light transmission and protection from debris, ensuring the auxiliary lights remain effective while being shielded from damage. The removable flexible band, sub-component number 502-c, is used to secure the light protector in place. This band is designed to provide sufficient elasticity to maintain a secure fit while allowing for easy removal and replacement. The purpose of the removable flexible band is to ensure that the light protector remains securely attached to the auxiliary light, maintaining its protective function. This band can be adjusted for tightness to ensure a snug fit, further enhancing the security of the light protector.

The light protector as a whole is adapted to the contour and design of the vehicle's body, providing a seamless aesthetic integration while ensuring the auxiliary driving lights are shielded. This adaptation not only enhances the aesthetic appeal of the vehicle but also ensures that the auxiliary lights are protected from flying debris, which could otherwise damage the lights and impair their function. In summary, the light protector (component 502) is a system designed to protect auxiliary driving lights from damage. It comprises a removable semi-flexible auxiliary light protector, a removable lens, and a removable flexible band, each with specific attributes and purposes. The semi-flexible protector provides a durable barrier, the lens ensures optimal light transmission and protection, and the flexible band secures the protector in place. Together, these components ensure the auxiliary lights remain functional and protected, enhancing the vehicle's visibility and safety.

The system/component number 502-a (FIG. 19B), identified as the Removable Semi-Flexible Auxiliary Light Protector, is a sub-component of the light protection system designed to safeguard auxiliary driving lights. This sub-component is configured to protect auxiliary driving lights from flying debris, ensuring the lights remain functional and undamaged. The removable semi-flexible auxiliary light protector is sized to fit over and about a perimeter of an auxiliary light, providing a secure attachment and coverage. This fitting ensures that the protector remains in place, effectively shielding the auxiliary lights from external elements and impacts. The removable semi-flexible auxiliary light protector is made from a durable, impact-resistant material capable of withstanding harsh environmental conditions and providing a reliable barrier against debris. This material selection is for maintaining the integrity and functionality of the auxiliary lights, especially in challenging driving conditions. The protector's semi-flexible nature allows it to conform to the shape of the auxiliary light, ensuring a snug fit that enhances its protective capabilities.

The removable semi-flexible auxiliary light protector is used to cover the auxiliary light, forming a part of the light protector assembly that includes a removable lens and a removable flexible band. The removable lens is sized to fit within the removable semi-flexible auxiliary light protector, ensuring compatibility and proper fitting for effective protection and aesthetic integration. The removable flexible band is used to secure the protector in place, maintaining its position and ensuring continuous protection of the auxiliary lights. The light protector, including the removable semi-flexible auxiliary light protector, is designed to add a design feature to the vehicle it is mounted on, enhancing the vehicle's aesthetic appeal while providing functional protection. The light protector is adapted to the contour and design of the vehicle's body, ensuring seamless aesthetic integration and adequate shielding of the auxiliary driving lights. In summary, the removable semi-flexible auxiliary light protector (system/component number 502-a) is a sub-component of the light protection system, designed to cover and protect auxiliary driving lights from flying debris and environmental impacts. It is made from a durable, impact-resistant material and is sized to fit securely over the auxiliary light, ensuring effective protection and aesthetic integration with the vehicle's design. The protector works in conjunction with a removable lens and a removable flexible band to form a light protection system that enhances the vehicle's visibility and safety.

The removable lens, identified as system/component number 502-b (FIG. 19B), is a sub-component of the light protector system designed to fit within the removable semi-flexible auxiliary light protector. This lens is sized to ensure compatibility and proper fitting with the light protector. The removable lens is made from materials including transparent polymers such as polycarbonate, acrylic, or polyethylene terephthalate, and glasses such as tempered glass or laminated glass. These materials are chosen to provide an optimal balance between light transmission and protection from debris, ensuring that the lens not only fits well but also performs its protective function effectively. The removable lens is integral to the overall functionality of the light protector. The light protector itself is configured to protect auxiliary driving lights from flying debris, comprising a removable semi-flexible auxiliary light protector, a removable lens, and a removable flexible band. The auxiliary driving lights are designed to provide relatively long-range illumination forward of a vehicle, enhancing the visibility of distant objects and increasing the vehicle's visibility and conspicuity to oncoming traffic. The standard headlamp system provides primary illumination, supplemented or replaced by the auxiliary driving lights, which are protected by the light protector.

The removable lens, being a part of this system, ensures that the auxiliary lights are shielded from debris while maintaining the necessary light transmission for effective illumination. The lens is sized to fit within the removable semi-flexible auxiliary light protector, ensuring a secure and compatible fit. This fitting is for the lens to perform its function without hindrance, providing a seamless integration with the light protector. Additionally, the removable lens is designed to be easily replaceable, allowing for maintenance and ensuring the longevity of the light protection system. The lens's material properties, such as being made from durable and impact-resistant materials, further enhance its protective capabilities, ensuring that the auxiliary lights remain functional and undamaged in harsh environmental conditions. Overall, the removable lens (502-b) plays a role in the light protection system by ensuring that the auxiliary driving lights are protected while maintaining optimal light transmission. This integration of materials and design considerations ensures that the light protector not only serves its protective function but also adds to the aesthetic and functional value of the vehicle.

The removable flexible band, identified as system/component number 502-c (FIG. 19B), is a sub-component of the light protector system. This band is designed to secure the light protector in place, ensuring that the auxiliary driving lights are shielded from external elements and impacts. The removable flexible band is used to secure the protector in place. This action is to maintain the protective function of the light protector, ensuring that it remains attached to the auxiliary light. The removable flexible band is described as being used to secure the protector in place. This is to ensure the light protector remains attached to the auxiliary light, thereby protecting and enhancing the functionality of the auxiliary lights. The band is designed to provide sufficient elasticity to maintain a secure fit while allowing for easy removal and replacement. This material selection is for the band to perform its function effectively. The removable flexible band is also involved in several procedural steps, including replacing the removable flexible band in the light protector and adjusting the tightness of the removable flexible band on the light protector. These actions ensure that the light protector can be maintained and adjusted as needed to provide protection for the auxiliary lights.

The attributes of the removable flexible band include its elasticity, which is necessary to maintain a secure fit while allowing for easy removal and replacement. This attribute is for the band to perform its function of securing the light protector in place. The band is part of the light protector system, which comprises a removable semi-flexible auxiliary light protector, a removable lens, and the removable flexible band itself. In summary, the removable flexible band (502-c) is an integral part of the light protector system, designed to secure the protector in place and ensure the auxiliary driving lights are protected from debris and other external elements. Its elasticity and ability to be adjusted and replaced are features that contribute to the overall functionality and effectiveness of the light protection system.

Turning attention back to FIG. 19A, the auxiliary driving lights, identified as system/component number 504, are a component of the light protection system designed to provide additional illumination for vehicles. These lights are configured to provide additional illumination, enhancing the visibility of distant objects, supplementing or replacing the high beam of a standard headlamp system, and increasing the vehicle's visibility and conspicuity to oncoming traffic. The auxiliary driving lights are designed to provide relatively long-range illumination forward of an automobile, motorcycle, recreational vehicle, buses, and trucks, which enhances the visibility of distant objects. This is particularly useful in poorly lit conditions or during night driving, improving safety and preventing accidents by making the vehicle more noticeable to other drivers. The auxiliary driving lights are protected by a light protector, which comprises a removable semi-flexible auxiliary light protector, a removable lens, and a removable flexible band.

The light protector is configured to protect the auxiliary driving lights from flying debris, ensuring that the lights remain functional and undamaged. The removable semi-flexible auxiliary light protector is sized to fit over and about a perimeter of an auxiliary light, providing a secure fit that protects the auxiliary light from external elements and debris. This protector is made from a durable, impact-resistant material capable of withstanding harsh environmental conditions and providing a reliable barrier against debris. The removable lens is sized to fit within the removable semi-flexible auxiliary light protector, ensuring compatibility and proper fitting with the light protector. The lens is made from materials including transparent polymers such as polycarbonate, acrylic, or polyethylene terephthalate, and glasses such as tempered glass or laminated glass. This ensures an optimal balance between light transmission and protection from debris, maintaining the functionality of the auxiliary driving lights while providing necessary protection. The removable flexible band is used to secure the protector in place, ensuring that the light protector remains attached to the auxiliary light. The band is selected for its sufficient elasticity to maintain a secure fit while allowing for easy removal and replacement.

This flexibility ensures that the light protector can be easily adjusted or replaced as needed, maintaining the protective function of the system. The vehicle, which is configured to use the auxiliary driving lights and the light protector, integrates these components seamlessly into its design. The light protector is adapted to the contour and design of the vehicle's body to provide a seamless aesthetic integration while ensuring the auxiliary driving lights are shielded. This not only protects the auxiliary lights but also adds a design feature to the vehicle, enhancing its overall aesthetic appeal. In summary, the auxiliary driving lights (component 504) are a part of the light protection system, providing additional illumination and enhancing vehicle safety. They are protected by a light protector comprising a removable semi-flexible auxiliary light protector, a removable lens, and a removable flexible band, all designed to ensure the lights remain functional and undamaged while integrating seamlessly with the vehicle's design.

The vehicle integration component, identified as system/component number 506 (FIG. 19A), plays a role in the overall light protection system for a vehicle. This component ensures that the light protector is integrated with the vehicle's design, providing both functional and aesthetic benefits. The vehicle is configured to use the auxiliary driving lights and the light protector. The light protector comprises a removable semi-flexible auxiliary light protector, a removable lens, and a removable flexible band. The primary purpose of this integration is to protect and enhance the functionality of the auxiliary lights. The auxiliary driving lights are designed to provide relatively long-range illumination forward of an automobile, motorcycle, recreational vehicle, buses, and trucks, which enhance the visibility of distant objects. These lights are intended to supplement and/or to replace the high beam of a standard headlamp system and to increase the vehicle's visibility and conspicuity to oncoming traffic.

The light protector is adapted to the contour and design of the vehicle's body to provide a seamless aesthetic integration while ensuring the auxiliary driving lights are shielded. This adaptation adds a design feature to the vehicle, enhancing its aesthetic appeal. The light protector is mounted on the vehicle, comprising a removable semi-flexible auxiliary light protector, a removable lens, and a removable flexible band. The purpose of the light protector in this context is to enhance the aesthetic appeal of the vehicle by adding a design feature when mounted on it. The removable semi-flexible auxiliary light protector is used to cover the auxiliary light. It is made from a durable, impact-resistant material capable of withstanding harsh environmental conditions and providing a reliable barrier against debris. This protector is sized to fit over and about a perimeter of an auxiliary light, ensuring a secure attachment and coverage of the auxiliary light.

The purpose of using the removable semi-flexible auxiliary light protector is to cover and protect the auxiliary light from flying debris and damage. The removable lens is sized to fit within the removable semi-flexible auxiliary light protector. It is made from materials including transparent polymers such as polycarbonate, acrylic, or polyethylene terephthalate, and glasses such as tempered glass or laminated glass. The purpose of the removable lens being sized to fit within the removable semi-flexible auxiliary light protector is to ensure compatibility and proper fit for effective protection and aesthetic integration. The lens is shaped to provide an optimal balance between light transmission and protection from debris. The removable flexible band is used to secure the protector in place. It is produced by selecting a material that provides sufficient elasticity to maintain a secure fit while allowing for easy removal and replacement. The purpose of the removable flexible band is to ensure that the light protector remains securely attached to the auxiliary light, maintaining its protective function.

In summary, the vehicle integration component (506) ensures that the light protector, comprising a removable semi-flexible auxiliary light protector, a removable lens, and a removable flexible band, is integrated with the vehicle's design. This integration not only protects the auxiliary driving lights from flying debris but also enhances the vehicle's aesthetic appeal. The auxiliary driving lights provide additional long-range illumination, supplementing or replacing the high beam of the standard headlamp system and increasing the vehicle's visibility and conspicuity to oncoming traffic.

The standard headlamp system, identified as component number 508 (FIG. 19A), is an element in the light protection system for a vehicle. This system is configured to provide primary illumination, which is supplemented or replaced by auxiliary driving lights. The auxiliary driving lights are designed to enhance the visibility of distant objects by providing relatively long-range illumination forward of the vehicle, which includes automobiles, motorcycles, recreational vehicles, buses, trucks, and heavy machinery such as those used in agriculture, mining, and surface mining. These lights are intended to supplement or to replace the high beam of the standard headlamp system and increase the vehicle's visibility and conspicuity to oncoming traffic, thereby improving safety and preventing accidents.

The standard headlamp system works in conjunction with or is replaced by the auxiliary driving lights to ensure optimal illumination. The auxiliary driving lights are configured to provide additional illumination, enhancing the visibility of distant objects for the driver and improving overall safety and driving conditions. This is particularly useful in poorly lit conditions or during night driving. The auxiliary driving lights, along with the high beam of the standard headlamp system, increase the vehicle's visibility and conspicuity to oncoming traffic, making the vehicle more noticeable to other drivers and reducing the risk of accidents. The light protector, which is a component of the light protection system, is configured to protect the auxiliary driving lights from flying debris. This protector comprises a removable semi-flexible auxiliary light protector, a removable lens, and a removable flexible band.

The removable semi-flexible auxiliary light protector is used to cover the auxiliary light, providing a durable and impact-resistant barrier capable of withstanding harsh environmental conditions. This protector is sized to fit over and about the perimeter of an auxiliary light, ensuring a secure attachment and coverage of the auxiliary light. The removable lens is sized to fit within the removable semi-flexible auxiliary light protector, ensuring compatibility and proper fitting with the light protector. This lens is made from materials including transparent polymers such as polycarbonate, acrylic, or polyethylene terephthalate, and glasses such as tempered glass or laminated glass. The lens is shaped to provide an optimal balance between light transmission and protection from debris. The removable flexible band is used to secure the protector in place, ensuring that the light protector remains attached to the auxiliary light. This band is produced from a material that provides sufficient elasticity to maintain a secure fit while allowing for easy removal and replacement. The band can also be adjusted for tightness to ensure the protector remains securely attached. The vehicle, which integrates the light protector, is adapted to the contour and design of the vehicle's body to provide a seamless aesthetic integration while ensuring the auxiliary driving lights are shielded.

This integration adds a design feature to the vehicle, enhancing its aesthetic appeal. In summary, the standard headlamp system (component number 508) works in conjunction with the auxiliary driving lights to provide illumination for the vehicle. The light protector, comprising a removable semi-flexible auxiliary light protector, a removable lens, and a removable flexible band, ensures that the auxiliary driving lights are protected from flying debris while maintaining a secure fit and aesthetic integration with the vehicle. This system enhances visibility, safety, and the overall driving experience.

In the foregoing description, it will be readily appreciated by those skilled in the art that modifications may be made to the invention without departing from the concepts disclosed herein. Such modifications are to be considered as included in the following claims, unless the claims by their language expressly state otherwise.

What is claimed is:

1. A light protection system for a vehicle, comprising: a light protector configured to protect auxiliary driving lights, wherein the light protector comprises a removable semi-flexible auxiliary light protector, a removable lens, and a removable flexible band; the auxiliary driving lights configured to provide additional illumination; the vehicle configured to use the auxiliary driving lights and the light protector; a standard headlamp system configured to provide primary illumination, supplemented and/or replaced by the auxiliary driving lights; wherein the light protector is configured to protect the auxiliary driving lights from flying debris.

2. The light protection system of claim 1, wherein the removable semi-flexible auxiliary light protector is sized to fit over and about a perimeter of an auxiliary light.

3. The light protection system of claim 1, wherein the removable lens is sized to fit within the removable semi-flexible auxiliary light protector.

4. The light protection system of claim 1, wherein the removable lens is made from materials including transparent polymers such as polycarbonate, acrylic, or polyethylene terephthalate, and glasses such as tempered glass or laminated glass.

5. The light protection system of claim 1, wherein the removable flexible band is used to secure the protector in place.

6. The light protection system of claim 1, wherein the vehicle is mounted with the light protector, and the light protector is specifically adapted to the contour and design of the vehicle's body to provide a seamless aesthetic integration while ensuring the auxiliary driving lights are adequately shielded.

7. The light protection system of claim 1, wherein the auxiliary light is covered by the removable semi-flexible auxiliary light protector, which is made from a durable, impact-resistant material capable of withstanding harsh environmental conditions and providing a reliable barrier against debris.

8. A method of protecting auxiliary lights on a vehicle, comprising: providing a light protector comprising a removable semi-flexible auxiliary light protector, a removable lens, and a removable flexible band; mounting the light protector on the auxiliary lights of the vehicle; using the auxiliary lights to provide additional illumination; using a standard headlamp system to provide primary illumination, supplemented and/or replaced by the auxiliary lights; protecting the auxiliary lights from flying debris using the light protector.

9. The method of claim 8, wherein the removable semi-flexible auxiliary light protector is sized to fit over and about a perimeter of an auxiliary light.

10. The method of claim 8, wherein the removable lens is sized to fit within the removable semi-flexible auxiliary light protector.

11. The method of claim 8, wherein the removable flexible band is used to secure the protector in place.

12. The method of claim 8, wherein the auxiliary light is covered by the removable semi-flexible auxiliary light protector.

13. The method of claim 8, further comprising the step of adjusting the position of the light protector on the auxiliary lights.

14. The method of claim 8, further comprising the step of replacing the removable semi-flexible auxiliary light protector in the light protector.

15. The method of claim 8, further comprising the step of replacing the removable flexible band in the light protector.

16. The method of claim 8, further comprising the step of adjusting the tightness of the removable flexible band on the light protector; whereby differing diameters and flexible band sizes measured by their circumference that can be used to ensure proper elasticity on various sized light protectors and/or light covers.

17. A method of making a light protection system for a vehicle, comprising: fabricating a removable semi-flexible auxiliary light protector; forming a removable lens to fit within the removable semi-flexible auxiliary light protector; producing a removable flexible band to secure the light protector; and assembling the light protector by attaching the removable lens and the removable flexible band to the removable semi-flexible auxiliary light protector.

18. The method of claim 17, wherein the fabricating of the removable semi-flexible auxiliary light protector includes using a material that is durable and impact-resistant.

19. The method of claim 17, wherein the forming of the removable lens includes shaping the lens to provide an optimal balance between light transmission and protection from debris.

20. The method of claim 17, wherein the producing of the removable flexible band includes selecting a material that provides sufficient elasticity to maintain a secure fit while allowing for easy removal and replacement.
